(19) United States
(12) Patent Application Publication
(10) Pub. No.: US 2022/0032830 A1
(43) Pub. Date: Feb. 3, 2022

(54) VEHICLE SEAT WITH MULTIPLE AND INDEPENDENTLY OPERATED TEMPERATURE CONTROL STRUCTURES

(71) Applicant: Lear Corporation, Southfield, MI (US)

(72) Inventors: Karl Henn, New Hudson, MI (US); Bradley C. Duncan, Harrison Township, MI (US); Vyachislav Ivanov, West Bloomfield, MI (US)

(73) Assignee: Lear Corporation, Southfield, MI (US)

(21) Appl. No.: 16/944,223

(22) Filed: Jul. 31, 2020

(51) Int. Cl. B60N 2/56; B60N 2/00

(52) U.S. Cl. CPC B60N 2/5678; G06K 9/00288; B60N 2/002; B60N 2/5621

(57) ABSTRACT

A seat includes a seat bottom portion and a seat back portion that is supported relative to the seat bottom portion. A first temperature control structure is provided in a first region of the seat bottom portion or the seat back portion and adapted to provide a first heating, cooling, and/or ventilating effect therein. A second temperature control structure provided in a second region of the seat bottom portion or the seat back portion and adapted to provide a second heating, cooling, and/or ventilating effect therein. An input device is provided that generates an input signal. A controller is configured to operate the first temperature control structure and the second temperature control structure independently of one another in response to the input signal.

### BACKGROUND OF THE INVENTION

This invention relates in general to systems that provide for the heating, cooling, and/or ventilating of a seat for the comfort of an occupant sitting thereon. In particular, this invention relates to an improved temperature control system for a vehicle seat that provides for the localized applications of heating, cooling, and/or ventilating effects in multiple and independently operated zones thereof in accordance with the temperature sensitivities of different regions of the occupant.

Vehicles, such as passenger cars, frequently include one or more seats for supporting an occupant thereon. A typical vehicle seat includes a seat bottom portion and a seat back portion, each of which includes a structural frame having supporting and cushioning features provided thereon. Each of the structural frames is typically formed from a relatively rigid material, such as steel or aluminum. The supporting and cushioning features typically include one or more springs supported on the structural frame, a foam bun supported on the springs, and an external trim or upholstery layer supported on the foam bun. These features make the seat bottom portion and the seat back portion comfortable for the occupant and provide an aesthetically pleasing appearance.

In many modern vehicle seats, a heating system, a cooling system, and/or a ventilating system is provided within the seat for the comfort of the occupant sitting thereon. A typical heating system for a vehicle seat may include a source of electrical energy that is selectively connected to a heating mat provided within the vehicle seat. When the source of electrical energy is energized, electrical current flows through an electrically conductive wire contained in the heating mat. Because of its inherent resistance to the flow of electrical current therethrough, the electrically conductive wire generates heat, which is radiated through the heating mat and the vehicle seat to the body of the occupant. A typical cooling system for a vehicle may include a thermoelectric device (TED) that creates a difference in temperature between two sides thereof when a voltage is applied across the device. Heat is thus drawn from the surface of the seat (and, thus, the body of the occupant) and is conducted away therefrom by air or fluid flow. A typical ventilating system for a vehicle seat may include a fan that is selectively energized to move air through one or more passageways provided in the vehicle seat. When the fan is energized, the air moving through the passageways removes heat from the body of the occupant sitting on the vehicle seat.

In a conventional vehicle seat, the heating, cooling, and/or ventilating system provides the heating, cooling, and/or ventilating effects generally uniformly throughout the entire seat bottom portion and/or the seat back portion. Although these conventional heating, cooling, and/or ventilating systems have been effective, it is known that different regions of the human body (such as the neck, upper back, lower back, thigh, and buttock regions, for example) have different sensitivities to such heating, cooling, and ventilating effects. Consequently, when known heating, cooling, and/or ventilating systems are operated, a first region of the occupant may achieve a desired comfort level much sooner than a second region of the occupant obtains that same desired comfort level, which may result in an unpleasant sensation. Thus, it would be desirable to provide an improved temperature control system for a vehicle seat that provides for the localized applications of heating, cooling, and/or ventilating effects in multiple and independently operated zones thereof in accordance with the temperature sensitivities of different regions of the body of the occupant.

### SUMMARY OF THE INVENTION

This invention relates to an improved temperature control system for a vehicle seat that provides for the localized applications of heating, cooling, and/or ventilating effects in multiple and independently operated zones thereof in accordance with the temperature sensitivities of different regions of the body of the occupant. A seat includes a seat bottom portion and a seat back portion that is supported relative to the seat bottom portion. A first temperature control structure is provided in a first region of the seat bottom portion or the seat back portion and adapted to provide a first heating, cooling, and/or ventilating effect therein. A second temperature control structure provided in a second region of the seat bottom portion or the seat back portion and adapted to provide a second heating, cooling, and/or ventilating effect therein. An input device is provided that generates an input signal. A controller is configured to operate the first temperature control structure and the second temperature control structure independently of one another in response to the input signal.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a conventional vehicle seat that includes a known temperature control structure for providing uniform heating, cooling, and/or ventilating effects therein.

FIG. 2 is a perspective view of a vehicle seat that includes an improved temperature control system for a vehicle seat that provides multiple and independently operated zones thereof in accordance with this invention.

FIG. 3 is a block diagram of the improved temperature control system illustrated in FIG. 2.

### DETAILED DESCRIPTION OF THE PREFERRED EMBODIMENT

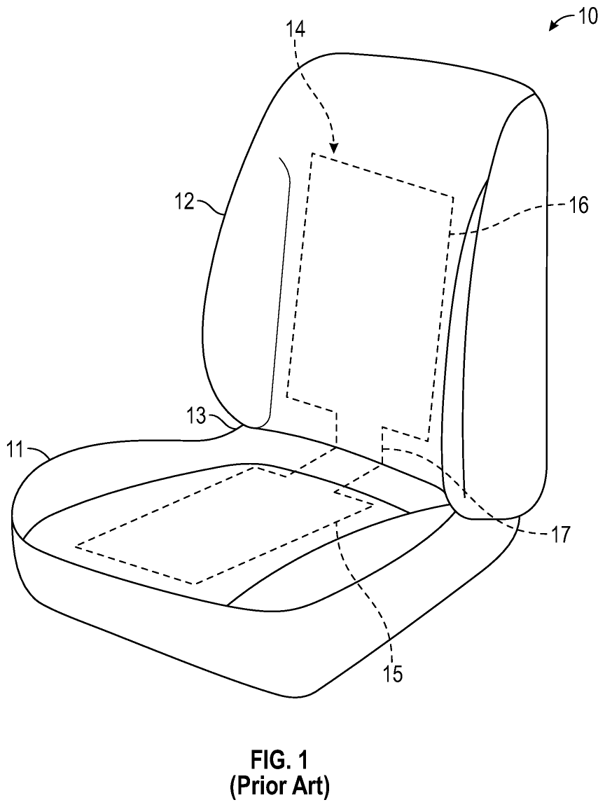

Referring now to the drawings, there is illustrated in FIG. 1 a conventional vehicle seat, indicated generally at 10, that is known in the art. The conventional vehicle seat 10 includes a seat bottom portion 11 and a seat back portion 12 that is supported on the seat bottom portion 11 by a hinge portion 13. The conventional vehicle seat 10 further includes a temperature control system, indicated generally at 14, for providing uniform heating, cooling, and/or ventilating of the seat bottom portion 11 and/or the seat back portion 12. The illustrated conventional temperature control system 14 includes a first portion 15 that is provided in the seat bottom portion 11 of the vehicle seat 10, a second portion 16 that is provided in the seat back portion 12 of the vehicle seat 10, and a third portion 17 that extends between the first portion 15 and the second portion 16. The illustrated temperature control structure 14 thus defines a single zone that provides for the uniform application of heating, cooling, and/or ventilating effects to an occupant (not shown) sitting on the conventional vehicle seat 10.

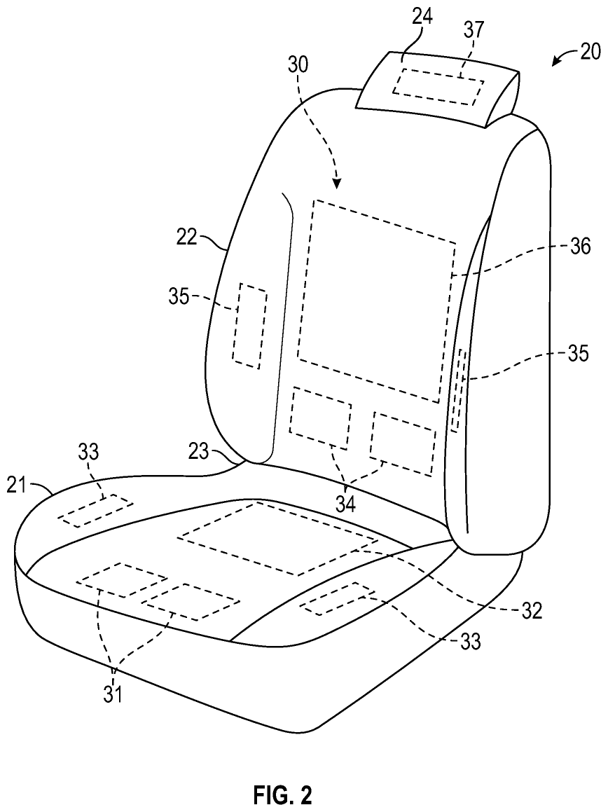

Referring now to FIG. 2, there is illustrated an improved vehicle seat, indicated generally at 20, in accordance with this invention. The illustrated vehicle seat 20 includes a seat bottom portion 21 and a seat back portion 22. The illustrated seat back portion 22 is pivotably supported on the seat bottom portion 21 by a hinge portion 23. However, the seat back portion 22 may be supported in any desired manner relative to the seat bottom portion 21. Also, the illustrated vehicle seat 20 includes an optional headrest 24 that is supported on the seat back portion 22.

As is well known, the vehicle seat 20 is configured for installation in a vehicle (not shown) and is adapted to support an occupant thereon. However, it will be understood that the vehicle seat 20 may be installed and/or used in any other environment, including those not related to vehicles. The illustrated vehicle seat 20 is, in large measure, conventional in the art and is intended merely to illustrate one environment in which this invention may be used. Thus, the scope of this invention is not intended to be limited for use with the specific structure of the vehicle seat 20 illustrated in FIG. 2 or with vehicle seats in general. On the contrary, as will become apparent below, this invention may be used in any desired environment for the purposes described below.

The vehicle seat 20 of this invention also includes a temperature control system, indicated generally at 30, in accordance with this invention. As mentioned above, it is known that different regions of the human body (such as the neck, upper back, lower back, thigh, and buttock regions, for example) have different sensitivities to heating, cooling, and ventilating effects. The temperature control system 30 of this invention provides for the localized applications of these heating, cooling, and/or ventilating effects in multiple and independently-operated zones thereof in accordance with these temperature sensitivities of different regions of the occupant. To accomplish this, the temperature control system 30 of this invention includes a plurality of individual temperature control structures (T.C.S. in the drawings) in either or both of the seat bottom portion 21 and the seat back portion 22.

Specifically, the illustrated temperature control system 30 includes a first seat bottom temperature control structure 31, a second seat bottom temperature control structure 32, a third seat bottom temperature control structure 33, a first seat back temperature control structure 34, a second seat back temperature control structure 35, a third seat back temperature control structure 36, and a headrest temperature control structure 37. The first seat bottom temperature control structure 31 is located toward the front of the seat bottom portion 21 of the vehicle seat 20, at a location where the thighs of the occupant of the vehicle seat 20 would normally be supported during use. The second seat bottom temperature control structure 32 is located toward the rear of the seat bottom portion 21 of the vehicle seat 20, at a location where the buttocks of the occupant of the vehicle seat 20 would normally be supported during use. The third seat bottom temperature control structure 33 is located in each of the side bolsters of the seat bottom portion 21 of the vehicle seat 20, at locations where the sides of the thighs and buttocks of the occupant of the vehicle seat 20 would normally be supported during use. The first seat back temperature control structure 34 is located toward the bottom of the seat back portion 22 of the vehicle seat 20, at a location where the lower back of the occupant of the vehicle seat 20 would normally be supported during use. The second seat back temperature control structure 35 is located in each of the side bolsters of the seat back portion 22 of the vehicle seat 20, at locations where the sides of the torso of the occupant of the vehicle seat 20 would normally be supported during use. The third seat back temperature control structure 36 is located toward the top of the seat back portion 22 of the vehicle seat 20, at a location where the upper back of the occupant of the vehicle seat 20 would normally be supported during use. The fourth seat back temperature control structure 37 is located in the headrest 24 supported on the seat back portion 22 of the vehicle seat 20, where the head and/or neck of the occupant of the vehicle seat 20 would normally be supported during use.

As shown in FIG. 2, some of the individual temperature control structures (in the illustrated embodiment, the first seat bottom temperature control structure 31, the third seat bottom temperature control structure 33, the first seat back temperature control structure 34, and the second seat back temperature control structure 35) are provided in multiple zones of the vehicle seat 20. Each of the multiple zones within each of such temperature control structures are controlled uniformly, although such is not required. Conversely, others of the individual temperature control structures (in the illustrated embodiment, the second seat bottom temperature control structure 32, the third seat back temperature control structure 36, and the headrest temperature control structure 37) are provided in single zones of the vehicle seat 20. It will be appreciated that each of the individual temperature control structures 31-37 may be embodied with any desired number of such zones.

Furthermore, each of the individual temperature control structures 31-37 may be embodied as any desired structure for providing the desired heating, cooling, and/or ventilating effects to the vehicle seat 20. For example, each of the structures for providing the heating effects to the vehicle seat 20 may include a source of electrical energy that is selectively connected to a heating mat as described above. Alternatively, each of the structures for providing the cooling effects to the vehicle seat 20 may include a thermoelectric device (TED) as also described above. Lastly, each of the structures for providing the ventilating effects to the vehicle seat 20 may include a fan that is selectively energized to move air through one or more passageways, as also described above. The scope of this invention is not intended to be limited to any particular structure for providing the heating, cooling, and/or ventilating effects to the vehicle seat 20.

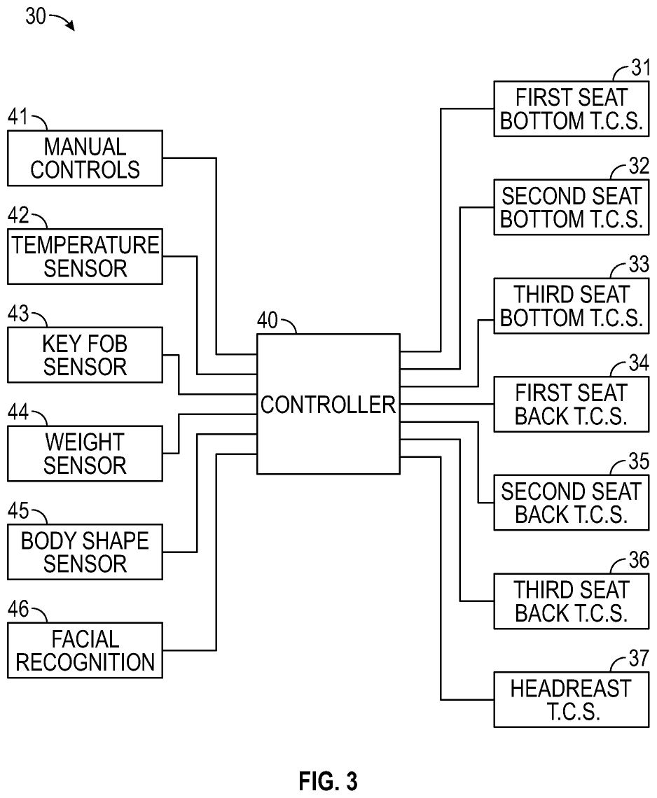

FIG. 3 is a block diagram of the improved temperature control system 30 illustrated in FIG. 2. As shown therein, the temperature control system 30 includes a controller 40 that is connected to each of the individual temperature control structures 31-37. To accomplish this, the controller 40 receives input signals from one or more input devices. As will be explained in detail below, the input devices may include any or all of manually operated controls (which can be adjusted by an occupant sitting on the vehicle seat 20 to generate input signals that are representative of desired temperature or other operating conditions for the vehicle seat 20), sensing devices (which can automatically sense predetermined conditions of the vehicle seat 20 or other devices or areas to generate input signals that are representative thereof), and any other similar structures.

For example, in the illustrated embodiment, the controller 40 receives input signals from one or more of a manual control 41, a temperature sensor 42, a key fob sensor 43, a weight sensor 44, a body shape sensor 45, and a facial recognition device 46. The manual control 41 may be embodied as any conventional device or group of devices (such as a switch, button, dial, and the like) that may be manually operated by an occupant sitting on the vehicle seat 20 or other person to provide a desired input instruction (such as on/off, increase/decrease temperature, and the like) to the controller 40. The temperature sensor 42 may be embodied as any conventional device or group of devices that senses the temperature of a desired area (such as an interior area or an exterior area of the vehicle) or component of the vehicle (such as the vehicle seat 20). The key fob sensor 43 may be embodied as any conventional remote device or group of devices that is used to control access and/or operation of the vehicle. The weight sensor 44 may be embodied as any conventional device or group of devices that is provided for measuring the weight of the occupant sitting on the vehicle seat 20. The body shape sensor 45 may be embodied as any conventional device or group of devices (such as a camera) that can generate a signal that is representative of the body type of the occupant sitting on the vehicle seat 20. Lastly, the facial recognition device 46 may be embodied as any conventional device or group of devices (such as a camera) that can analyze the facial features of the occupant sitting on the vehicle seat 20 in order to determine the identity thereof.

The controller 40 is, of itself, conventional in the art and may, for example, be embodied as an electronic microprocessor. The controller 40 receives the input signals from the sensors 41-46 and, in response thereto, controls the operations each of the individual temperature control structures 31-37 in accordance with a predetermined algorithm. In particular, the controller 40 is adapted to provide for the localized applications of heating, cooling, and/or ventilating effects in multiple and independently operated zones thereof in accordance with the temperature sensitivities of different regions of the occupant. As mentioned above, it is known that different regions of the human body (such as the neck, upper back, lower back, thigh, and buttock regions, for example) have different sensitivities to heating, cooling, and ventilating. Consequently, when known heating, cooling, and/or ventilating systems are operated, a first region of the occupant may achieve a desired comfort level much sooner than a second region of the occupant obtains that same desired comfort level, which may result in an unpleasant sensation. This invention provides an improved temperature control system for the vehicle seat 20 that provides for the localized applications of heating, cooling, and/or ventilating effects in multiple and independently operated zones thereof in accordance with the temperature sensitivities of different regions of the occupant.

For example, the thigh, upper back, and neck regions of the human body normally exhibit higher skin temperatures than the buttock and lower back regions of the human body. Thus, when the temperature control system 30 is operated to effect cooling of the occupant of the vehicle seat 20, it would be desirable to initially operate the first seat bottom temperature control structure 31, the third seat bottom temperature control structure 33, the third seat back temperature control structure 36, and the headrest temperature control structure 37 to cool (and/or ventilate and thereby cool) the thigh, upper back, and head or neck regions of the occupant of the vehicle seat 20. This selective operation of the temperature control structures 31-37 would provide the quickest desirable body sensation and comfort. Thereafter (or simultaneously, if desired), the second seat bottom control structure 32, the first seat back temperature control structure 34, and the second seat back temperature control structure 35 can be operated to cool (and/or ventilate and thereby cool) the buttock and lower back regions of the occupant of the vehicle seat 20.

Similarly, it is known that the buttock and lower back regions of the human body are the areas that have the highest sweat rates. As a result, those regions could be overcooled, which would adversely affect the body sensation and comfort level of the occupant of the vehicle seat 20. To prevent this from occurring, the temperature control system 30 can be operated to initially provide a lower amount of cooling in these areas relative to the other areas of the occupant of the vehicle seat 20, with no cooling thereafter for long term comfort.

Additionally, it is known that the buttock and thigh regions of the occupant exhibit a significantly higher compression force against the seat bottom portion 21 of the vehicle seat 20 than is exerted by the lower back, upper back and neck regions of the occupant against the seat back portion 22 of the vehicle seat 20. As a result of this higher compression force, the physical distance between the occupant and the heating, cooling, and/or ventilating structures provided in the seat bottom portion 21 is smaller than the physical distance between the occupant and the heating, cooling, and/or ventilating structures provided in the seat back portion 22. Thus, the heating, cooling, and/or ventilating effects provided by the temperature control structures 31, 32, and 33 in the seat bottom portion 21 affect the buttock and thigh regions of the occupant more quickly than do the heating, cooling, and/or ventilating effects provided by the temperature control structures 34, 35, and 36 provided in the seat back portion 22 of the vehicle seat 20. The controller 40 can be programmed to optimize the application of heating, cooling, and/or ventilating in accordance with these situations or in any other manner.

If desired, the controller 40 can also be programmed to the adaptive to the desired heating, cooling, and/or ventilating needs of a particular user or a particular environmental condition. Adaptive control is a control method by which the controller 40 may change the operation of the temperature control system 30 in response to previous adjustments made by the occupant of the vehicle seat 20. For example, the controller 40 may identify a specific occupant of the vehicle seat 20 (such as by using one or more of the signals generated by the key fob sensor 43 or the facial recognition device 46) and record each of the adjustments that are made by that occupant over a period of time. Based upon those adjustments, the controller 40 may automatically adapt the operation of the temperature control system 30 to be more consistent with the desired effects requested by that occupant. Alternatively, the controller 40 may automatically adapt the operation of the temperature control system 30 based upon the weight of the occupant of the vehicle seat 20 (such as by using one or more of the signals generated by the weight sensor 44 or the body shape sensor 45). Lastly, the controller 40 may automatically adapt the operation of the temperature control system 30 based upon an environmental condition of the vehicle seat 20 (such as by using signals generated by the temperature sensor 42 regarding the internal and/or external temperature of the vehicle in which the vehicle seat 20 is supported).

The principle and mode of operation of this invention have been explained and illustrated in its preferred embodiment. However, it must be understood that this invention may be practiced otherwise than as specifically explained and illustrated without departing from its spirit or scope.

What is claimed is:

1. A seat comprising:
a seat bottom portion;
a seat back portion supported relative to the seat bottom portion;
a first temperature control structure provided in a first region of the seat bottom portion or the seat back portion and adapted to provide a first heating, cooling, and/or ventilating effect therein;
a second temperature control structure provided in a second region of the seat bottom portion or the seat back portion and adapted to provide a second heating, cooling, and/or ventilating effect therein;
an input device that generates an input signal; and
a controller that is configured to operate the first temperature control structure and the second temperature control structure independently of one another in response to the input signal.

2. The seat defined in claim 1 wherein the first temperature control structure is located in a first region of the seat bottom portion or the seat back portion where a first portion of an occupant having a first sensitivity to heating, cooling, and ventilating effects would normally be supported during use, and wherein the second temperature control structure is located in a second region of the seat bottom portion or the seat back portion where a second portion of the occupant having a second sensitivity to heating, cooling, and ventilating effects sensitivity to heating, cooling, and ventilating effects would normally be supported during use.

3. The seat defined in claim 1 wherein the first temperature control structure is a first seat bottom temperature control structure that is located toward a front of the seat bottom portion at a location where thighs of an occupant of the vehicle seat would normally be supported during use.

4. The seat defined in claim 3 wherein the second temperature control structure is a second seat bottom temperature control structure that is located toward a rear of the seat bottom portion at a location where buttocks of the occupant of the vehicle seat would normally be supported during use.

5. The seat defined in claim 4 further including a third seat bottom temperature control structure that is located in each of a pair of side bolsters of the seat bottom portion at locations where sides of the thighs and buttocks of the occupant of the vehicle seat would normally be supported during use.

6. The seat defined in claim 1 wherein the first temperature control structure is a first seat back temperature control structure that is located toward a bottom of the seat back portion at a location where a lower back of the occupant of the vehicle seat would normally be supported during use.

7. The seat defined in claim 6 wherein the second temperature control structure is a second seat back temperature control structure that is located in each of a pair of side bolsters of the seat back portion at a location where sides of a torso of the occupant of the vehicle seat would normally be supported during use.

8. The seat defined in claim 7 further including a third seat back temperature control structure that is located toward a top of the seat back portion where an upper back of the occupant of the vehicle seat would normally be supported during use.

9. The seat defined in claim 8 further including a fourth seat back temperature control structure that is located in a headrest supported on the seat back portion of the vehicle seat

10. The seat defined in claim 1 wherein the controller is responsive to one or more input devices for operating the first temperature control structure and the second temperature control structure.

11. The seat defined in claim 10 wherein the controller is responsive to a manual control.

12. The seat defined in claim 10 wherein the controller is responsive to a temperature sensor.

13. The seat defined in claim 10 wherein the controller is responsive to a key fob sensor.

14. The seat defined in claim 10 wherein the controller is responsive to a weight sensor.

15. The seat defined in claim 10 wherein the controller is responsive to a body shape sensor.

16. The seat defined in claim 10 wherein the controller is responsive to a facial recognition device.
